(19) United States
(12) Patent Application Publication
(10) Pub. No.: US 2019/0303992 A1
(43) Pub. Date: Oct. 3, 2019

(54) System and Method for Generating a Product Identifier Code

(71) Applicant: Iseby Solutions LLP, Pure (IN)

(72) Inventor: Adhokshaj Adya, Pune (IN)

(73) Assignee: Iseby Solutions LLP, Pune (IN)

(21) Appl. No.: 16/309,105

(22) PCT Filed: Mar. 27, 2018
(86) PCT No.: PCT/IB2018/052077

§ 371 Date: Dec. 11, 2018

(51) Int. Cl. G06Q 30/06; G06K 7/14; G10L 15/26

(52) U.S. Cl. CPC G06Q 30/0623; G10L 15/26; G06K 7/1408

(57) ABSTRACT

The present disclosure describes system and method for generating a product identifier code 106. The system 101 is configured for receiving product information. The product information comprises at least one of price, product specifications, product images, predefined category of product, information of a user/recipient and a combination thereof. The system 101 is configured for processing the product information in order to generate the product identifier code 106. The system 101 is configured for generating the product identifier code 106 in a predefined colour based on the predefined category of the product. The system 101 is configured for transmitting the product identifier code 106 to a user device 103. The product identifier code 106 comprises the product information in form of code. The product identifier code 106 further displays at least one of user details, product text and a combination thereof.

### CROSS-REFERENCE TO RELATED APPLICATIONS AND PRIORITY

The present application claims priority from Indian patent application number 201721016723 filed on 12 May 2017; and Patent Cooperation Treaty WIPO 2018/207035 A1 filed on Mar. 27, 2018, the entire contents of both of which are hereby incorporated by reference in their entirety.

### TECHNICAL FIELD

The present invention in general relates to afield of data communications. More particularly, the invention relates to system and method for generating a product identifier code.

### BACKGROUND

In today's world, people are using internet for various useful purposes. Recently, more and more people are using the internet for purchasing items, services, etc. Current trends or modern age challenges people are aware of new methods of commerce, online banking, e-payments/cashless payments, etc. Currently, if a person wants to retrieve information of a particular product, he uses some keywords or name of the product and tries to find that particular product for which he is looking for. The person searches the product online and offline. Sometimes, searching activity is time-consuming and can be inconvenient and burdensome.

People usually prefer to look for products/services that are easy to locate and identify. Sometimes, people prefer walk into a store, find the desired products, have the products scanned at checkout, and pay at the store. Yet another way is to locate and purchase products using a catalog, newspaper, advertisement pamphlet or other printed media in order to first locate a product. Thus, there is a need of a smooth and quick process in order to eliminate the time-consuming activities carried out for finding a particular product.

### SUMMARY

Before the present apparatuses, methods and systems along with components related thereto are described, it is to be understood that this disclosure is not limited to the particular methods, apparatuses, systems and their arrangement as described, as there can be multiple possible embodiments which are not expressly illustrated in the present disclosure but may still be practicable within the scope of the invention. It is also to be understood that the terminology used in the description is for the purpose of describing the particular versions or embodiments only, and is not intended to limit the scope of the present application. This summary is not intended to identify essential features of the subject matter nor it is intended for use in detecting or limiting the scope of the subject matter.

In one embodiment, a system for generating a product identifier code is described. The system may comprise a system processor and a system memory. The system memory may be coupled with the system processor. The system processor may execute programmed instructions stored in the system memory. The system may be configured for receiving product information. The product information may comprise at least one of price, product specifications, product images, predefined category of product, information of a user/recipient and a combination thereof. The system may be configured for processing the product information in order to generate the product identifier code. The system may be configured for generating the product identifier code in a predefined colour based on predefined category of the product. The system may be configured for transmitting the product identifier code to a user device. The product identifier code may comprise the product information in form of code. The product identifier code may further display at least one of user details, product text and a combination thereof.

In another embodiment, a method for generating a product identifier code is described. The method may comprise receiving, by system processor, product information, wherein the product information comprises at least one of price, product specifications, product images, predefined category of product, information of a user/recipient and a combination thereof. The method may comprise processing, by the system processor, the product information in order to generate the product identifier code. The method may comprise generating, by the system processor, the product identifier code in a predefined colour based on the predefined category of the product. The method may comprise transmitting, by the system processor, the product identifier code to a user device wherein the product identifier code comprises the product information in form of code, wherein the product identifier code further displays at least one of user details, product text and a combination thereof.

In yet another embodiment, a product identifier code is described. The product identifier code may comprise product information. The product information may comprise at least one of price, product specifications, product images captured via user device, predefined category of product, information of a user/recipient and a combination thereof. The product identifier code may be formed of a predefined colour based on the predefined category of the product. The product identifier code may further display a code and at least one of user details, product text and a combination thereof.

### BRIEF DESCRIPTION OF THE DRAWINGS

The detailed description is described with reference to the accompanying Figures. In the Figures, the left-most digit(s) of a reference number identifies the Figure in which the reference number first appears. The same numbers are used throughout the drawings to refer like features and components.

FIG. 1 illustrates a network implementation 100 of system 101 for generating a product identifier code 106, in accordance with an embodiment of the present disclosure.

FIG. 2 illustrates a system 101 for generating a product identifier code 106, in accordance with an embodiment of the present disclosure.

FIG. 3 illustrates a method 300 for generating a product identifier code 106, in accordance with an embodiment of the present disclosure.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that, the singular forms “a,” “an,” and “the” include plural references unless the context clearly dictates otherwise. Although any methods similar or equivalent to those described herein can be used in the practice or testing of embodiments of the present disclosure, the exemplary methods are now described. The disclosed embodiments are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein.

The present disclosure describes a system and method for generating a product identifier code.

The product identifier code may be attached to the product. The product identifier code may enable users to retrieve the information of the product. The product identifier code may eliminate product searching activity for the users that is time consuming.

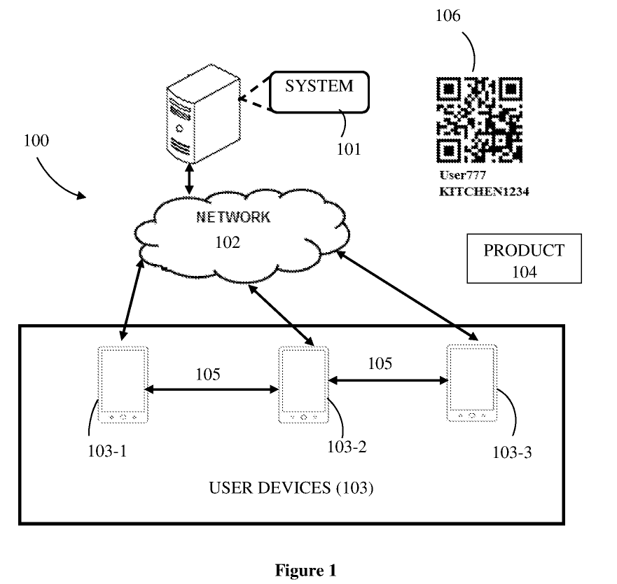

FIG. 1 illustrates a network implementation 100 of system 101 for generating a product identifier code 106, in accordance with an embodiment of the present disclosure. The system 101 may be capable of generating a product identifier code 106. The system 101 may be configured for receiving product information. The product information may be obtained by capturing details of the product 104. The product information may be captured via one or more user devices (103-1, 103-2 . . . 103-n). The one or more user devices (103-1, 103-2 . . . 103-n) may be connected via second network 105. The one or more user devices (103-1, 103-2 . . . 103-n) may be communicatively coupled with each other the through the second network 105. The second network 105 may be wired or wireless. Hereinafter one or more user devices (103-1, 103-2 . . . 103-n) may be also be referred as user device 103. The product information may comprise at least one of price, product specifications, product images, predefined category of product, information of a user/recipient and a combination thereof. The user device 103 may further transmit the product information to the system 101. The system 101 may be further configured for processing the product information. The product information may be processed in order to generate the product identifier code 106. The product identifier code 106 may be a QR (Quick Response) code or a bar code.

The system 101 may be configured for generating the product identifier code 106 in a predefined colour based on the predefined category of the product. The predefined colour may be assigned to the predefined category of the product. The system 101 may be configured for transmitting the product identifier code 106 to the user device 103. The product identifier code 106 may comprise the product information in form of code. The product identifier code 106 may further display at least one of user details, product text and a combination thereof. The user details and product text may comprise either alphabets or numerals or both. The product identifier code 106 may further comprise a name assigned to the system 101 in form of either alphabets or numerals or both. In one embodiment, a kitchen equipment may comprise a red colour product identifier code 106, depending upon the colour assigned for kitchen product/item. In one embodiment, a shower tap may comprise a blue colour product identifier code 106. The users may further ensure the correct product identifier code 106 by identifying the colour of the product identifier code 106.

It may be understood that the system 101 may also be implemented in a variety of computing systems, such as a laptop computer, a desktop computer, a notebook, a workstation, a mainframe computer, a server, a network server, a cloud server and the like. It will be understood that the system 101 may be accessed by multiple user devices through the user device 103 hereinafter. Examples of the user device 103 may include, but not limited to, a portable computer, a personal digital assistant, a handheld device, and a workstation. The system 101 is communicatively coupled user device 103 and the through a first network 102.

In one embodiment, the first network 102 and the second network 105 may be a wireless network, a wired network or a combination thereof. The first network 102 and the second network 105 can be implemented as one of the different types of networks, such as intranet, local area network (LAN), wide area network (WAN), the internet, and the like. The first network 102 and the second network 105 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the first network 102 may include a variety of network devices, including routers, bridges, servers, computing devices, storage devices, and the like.

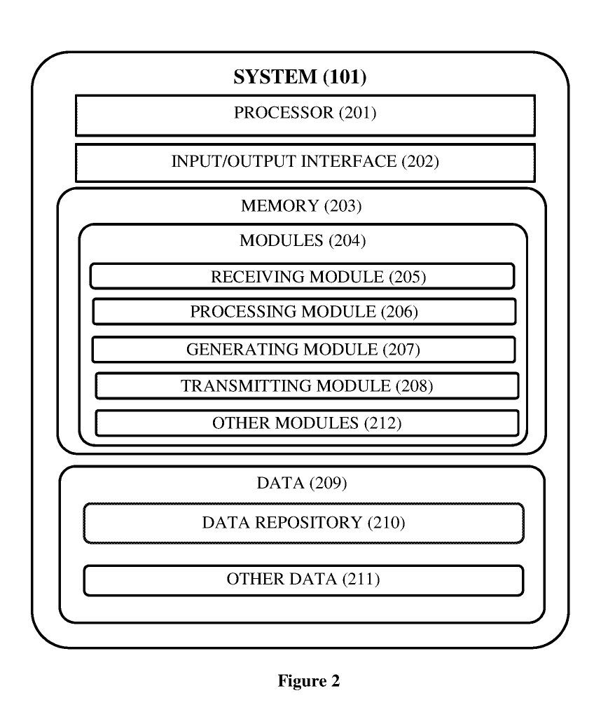

FIG. 2 illustrates a system 101 for generating a product identifier code 106, in accordance with an embodiment of the present disclosure. The system may comprise a system processor 201, an input/output interface 202 and a system memory 203. Hereinafter input/output interface 202 may also be referred as I/O interface. The processor 201 may be implemented as one or more microprocessors, microcomputers, microcontrollers, digital signal processors, central processing units, state machines, logic circuitries, and/or any devices that manipulate signals based on operational instructions. Among other capabilities, the processor 201 is configured to fetch and execute computer-readable instructions stored in the system memory 203.

The I/O interface 202 may include a variety of software and hardware interfaces, for example, a web interface, a graphical user interface, and the like. The I/O interface 202 may allow the system 101 to interact with a user directly or through the user devices 103. Further, the I/O interface 202 may enable the system 101 to communicate with other computing devices, such as web servers and external data servers (not shown). The I/O interface 202 can facilitate multiple communications within a wide variety of networks and protocol types, including wired networks, for example, LAN, cable, etc., and wireless networks, such as WLAN, cellular, or satellite. The I/O interface 202 may include one or more ports for connecting a number of devices to one another or to another server.

The system memory 203 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The system memory 203 may include modules 204 and data 209.

The modules 204 include routines, programs, objects, components, data structures, etc., which perform particular tasks or implement particular abstract data types. In one implementation, the modules 204 may include a receiving module 205, a processing module 206, a generating module 207, a transmitting module 208 and other modules 212.

The receiving module 205 may be configured to receive the product information from the one or more user devices 103. The processing module 206 may be configured to process the received product information. The generating module 207 may be configured to generate the product identifier code 106. The product identifier code 106 may be of a predefined colour, based on the predefined category of the product. The particular colour may be assigned to the particular category of the product. The product identifier code 106 may further display at least one of user details, product text and a combination thereof.

The transmitting module 208 may be configured to transmit the product identifier code 106 to the one or more user devices via the first network 102. The other modules 212 may include programs or coded instructions that supplement applications and functions of the system 101.

The data 209, amongst other things, serves as a repository for storing data processed, received, and generated by one or more of the modules 204. The data 209 may also include a data repository 210 and other data 211. The user profiles and the product information may be stored in the data repository 210. The other data 211 may include data generated as a result of the execution of one or more modules in the other module 212.

In one embodiment, a user may create a profile, via user device, on a computer based platform. The profile may comprise user details such as name, address, locality, age, sex, etc. By providing the details by the user 103, the account for the user is generated and registered with the system 101. Furthermore, the user id and the password may be generated for the logging into the system 101.

The working of the system 101 may be explained in detail referring to FIG. 2 as below. The system 101 may be used for generating the product identifier code 106 for the product. The user device 103 may enter the product information and may further capture images of the product 104. The product identifier code 106 may be shared, via the user device, with other user devices using a second network 105. The product identifier code 106 may be printed and can be attached to the product 104. The product identifier code 106 may be scanned by the other user devices in order to retrieve the product information. In one embodiment, a user may be a manufacturer of the one or more products 104. The manufacturer may enter the product information and attach the product identifier code 106 to the product. The users, via the user device, may scan the product identifier code 106 and may be further redirected to the manufacturer's product page present in the system 101. In one embodiment, a person who wish to purchase same product from the same manufacturer may scan the product identifier code 106 in order to retrieve the product information. The person may then select the product 104 for purchase or may save the product for buying in future. The user may select one of the payment options, on the user device 103, available for purchasing of the product 104. The product and payment information may be further transmitted to the system 101 in order to process the payment to an appropriate user/recipient. In yet another embodiment, the user may use a voice command feature, via the user device 103, in order to retrieve the product information. The user may read, as an input via user device, the user details and the product text as the voice command.

In another embodiment, the user may scan the product identifier code 106 via the user device 103 and further set a reminder for the product. The reminder may be for a particular day/date or time. The reminder may also be for a particular location. If the user is in a particular locality, the user device may alert/remind the user for the particular product. The product 104 may further be purchased by the even by setting a reminder. In yet another embodiment, the product identifier code may be shared with other user devices and may the user who shares the product identifier code 106 may earn points for sharing.

In yet another embodiment, a user may be a seller/merchant/retailer of the various products. The user, via the user device 103, may receive the product identifier code 106 of the one or more products 104. The product identifier code may comprise seller/merchant details (such as name and/or seller code) and the product text in form of alphanumeric characters. The user may print the product identifier code 106 and attach the product identifier code 106 (as a sticker) to one or more product 104. The one or more products 104 may be available in the store/shop/selling place of the user. Many people (as consumers or buyers) may visit the store for purchasing the one or more products 104. People present in the store may scan the product identifier code 106 in order to retrieve the information of the physical product. Additionally, the buyers may read the seller details and the product text in order to retrieve the product information. When the product information is received by a buyer in order to purchase the one or more products, the system 101 may provide some similar products as recommendations or may provide the same product 104 available with other sellers. The same product available with other sellers may enable price comparison for the consumer/buyer. The user device 103 may further provide available payment options in order to purchase the one or more products 104. In case the user does not carry the user device 103, he may note down the seller/merchant details and the product text in order to check the product information later.

In another embodiment, the user, via the user device 103, may share the product identifier code 106 with other users/user devices 103. The other users may be either regular consumers/buyers, contacts in user device's phonebook, family members, friends, relatives or any known person of the user. The other users may receive the product identifier code 106 on their respective user devices 103. The other users may further share the product identifier code 106 with other users as well. The sharing of the product identifier code 106 may show the details of the product in the decrypted form. The other users that have received the product identifier code 106 may have an option to see the QR code 106 or the product information on the user device 103. The users may receive several points by sharing the product identifier code 106 with other users, if one of the other user buys the one or more product 104. The points received may be utilized for purchase of the product 104 by the user. The present disclosure saves the time of the consumers/buyers for purchasing a product, thus making a transaction quick and easy. The consumers may repeat the transactions after a predefined period in order to buy the same product. The quick and easy transactions further enable eliminating need of the buyers to visit the store, thereby making the buyers' life simpler.

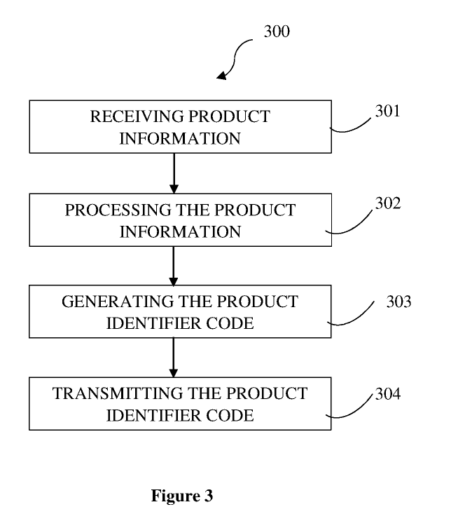

FIG. 3 illustrates a method 300 for generating a product identifier code 106, in accordance with an embodiment of the present disclosure. Initially, the user via the user device 103 may log into the system 101. At step 301, the system 101 may receive the product information via the user device 103. The user of the user device 103 may input the product information wherein the product information comprises of at least one of price, product specifications, product images, predefined category of product, information of a user/recipient and a combination thereof.

At step 302, the system 101 may process the product information in order to generate the product identifier code 106. The processing module 206 of the system 101 may access and process the received product information. At step 303, the system 101 may generate the product identifier code 106 in a predefined colour based on the predefined category of the product. The particular colour for the product identifier code 106 may be assigned to the particular category of the product.

At step 304, the system 101 may transmit the product identifier code 106 to the user device 103 via the first network 102. The product identifier code 106 may comprise the product information in form of code. The product identifier code 106 may further display at least one of user details, product text and a combination thereof.

In accordance with embodiments of the present disclosure, the system and method for generating a product identifier code described above may have following advantages including but not limited to:
A person can remotely select the product/service without a need to go to a store.
A person can also use voice command for selecting the product.
A person can select the product/service and set future date to proceed with the selection.
A person can select the product/service and set a particular geographic location/area to proceed with the selection.

The embodiments, examples and alternatives of the preceding paragraphs or the description and drawings, including any of their various aspects or respective individual features, may be taken independently or in any combination. Features described in connection with one embodiment are applicable to all embodiments, unless such features are incompatible.

We claim:

1. A system 101 for generating a product identifier code 106, the system comprising:
a system processor 201;
a system memory 203 coupled with the system processor 201, wherein the system processor 201 executes programmed instructions stored in the system memory 203 for,
receiving product information, wherein the product information comprises of at least one of price, product specifications, product images, predefined category of product, information of a user/recipient and a combination thereof;
processing the product information in order to generate the product identifier code 106;
generating the product identifier code 106 in a predefined colour based on the predefined category of the product;
transmitting the product identifier code to a user device 103 wherein the product identifier code 106 comprises the product information in the form of code, wherein the product identifier code 106 further displays at least one of user details, product text and a combination thereof,

2. The system of claim 1 further comprises an Input Output (I/O) interface 202, wherein the I/O interface 202 allows the system 101 to interact with the user device 103.

3. The system of claim 1, wherein the product identifier code 106 is either a QR (Quick Response) code or a bar code.

4. The system of claim 1, wherein the product identifier code 106 is scanned, via the user device, in order to retrieve the product information.

5. The system of claim 1, wherein voice command, via the one or more user devices, enables retrieving product information.

6. The system of claim 1, wherein the user details and the product text comprises either alphabets or numerals or both.

7. The system of claim 1, wherein the product identifier code 106 is printed and attached to the product 104.

8. The system of claim 1, wherein the product identifier code 106 can be transmitted to other user devices via network 105.

9. A method 300 for generating a product identifier code 106, the method comprising:
receiving, by system processor 201, product information, wherein the product information comprises of at least one of price, product specifications, product images, predefined category of product, information of a user/recipient and a combination thereof;
processing, by the system processor 201, the product information in order to generate the product identifier code 106;
generating, by the system processor 201, the product identifier code 106 in a predefined colour based on the predefined category of the product;
transmitting, by the system processor 201, the product identifier code 106 to a user device 103 wherein the product identifier code 106 comprises the product information in form of code, wherein the product identifier code 106 further displays at least one of user details, product text and a combination thereof.

10. A product identifier code 106 comprising:
product information, wherein the product information comprises at least one of price, product specifications, product images captured via user device, predefined category of product, information of a user/recipient and a combination thereof;
wherein the product identifier code 106 is formed of a predefined colour based on the predefined category of the product, wherein the product identifier code further displays a code and at least one of user details, product text and a combination thereof.

11. The code of claim 10, wherein the user details and the product text comprises either alphabets or numerals or both.
